(19) United States
(12) Patent Application Publication
(10) Pub. No.: US 2004/0052408 A1
(43) Pub. Date: Mar. 18, 2004

(54) Method and apparatus for electronically extracting information

(76) Inventors: Paul Sharman, Vancouver (CA); Geof Auchinleck, Vancouver (CA)

Correspondence Address: IPSOLON LLP, 805 SW BROADWAY, #2740, PORTLAND, OR, 97205, US

(21) Appl. No.: 10/246,301

(22) Filed: Sep. 17, 2002

(51) Int. Cl. G06K 9/00

(52) U.S. Cl. 382/128

(57) ABSTRACT

Indicia conveyed on histological sample carriers is illuminated and read by a digital camera to create a digital version of the indicia, which is processed to create an electronic representation of the information conveyed by the indicia.

### FIELD OF THE INVENTION

The illustrated invention relates generally to the electronic capture, storing and retrieving of information from laboratory samples, and more particularly to machine recognition systems for automatic reading of indicia marked on containers that hold tissue samples.

### BACKGROUND OF THE INVENTION

Tissue samples such as those used for histological determinations are often stored for long periods of time. There are numerous techniques and equipment available for storing such samples, but in all cases, most histological tissue sample storage systems utilize a system for marking the samples so that they may be correctly inventoried and identifiable for retrieval at a later time.

Cassettes such as those described in U.S. Pat. No. 3,674,396 represent one type of containment, storage and processing container for tissue samples for the purpose of histological determinations. Prior to using these cassettes the user marks the cassette with indicia that is used to identify the cassette. The indicia is typically marked on one face of the cassette with hand-printing using a pen or pencil, or machine-printing, using specialized equipment such as the MicroWriter available from RA Lamb, Eastbourne, UK (www.ralamb.com), although other marking systems such as bar codes may be used. The indicia are generally alphanumeric and are eye-readable by humans. In use, after a tissue sample is processed to remove moisture, it is embedded in paraffin wax to add rigidity and secure it to the cassette. After the sample has been embedded in wax, thin sections may be sliced from the embedded tissue sample on a microtome and placed on microscope slides for subsequent examination. These microscope slides are usually marked in the same manner and with the same indicia as the cassettes in order to relate the two. In some cases, during the embedding stage, excess paraffin wax adheres to the marked face of the cassette, potentially obscuring the markings.

After examination, the cassette and/or slide may then be stored in a sample repository, which typically is located at a remote location from the originating or examination laboratory. As noted, the cassettes and slides may be stored for many years—often for 25 years or more. The samples are usually stored in some kind of chronological order to ease future retrieval, identification and reexamination.

Many thousands of histological sample carriers such as the cassettes and slides described above may be stored for very long periods of time. Accurate inventory control of the stored samples is necessary because it is important to be able to locate a specific block or slide, retrieve it, and re-store it without losing it. This problem is usually addressed by storing the histological blocks and slides in numerical order, but this approach is very labour intensive, and is prone to error. For example, when identifying information marked on a cassette or slide is obscured by paraffin wax, the indicia may be read incorrectly by human technicians. Moreover, when samples are removed for re-examination at a later time, they may not be returned to the proper storage location. There is a need therefore for an automated system for managing the inventory of blocks and slides to address these problems.

### SUMMARY OF THE INVENTION

A method for electronically representing identification indicia on a tissue block comprises illuminating the indicia, generating a digital image of the indicia and processing the digital image to create an electronic representation of the information.

### BRIEF DESCRIPTION OF THE DRAWINGS

These and other objects, features and advantages of the present invention will become apparent upon reference to the following detailed description of the preferred embodiments and to the drawings wherein:

FIG. 1A is a dimetric view of a typical histological tissue cassette marked with typical alphanumeric identifying indicia.

FIG. 1B is a dimetric view of a typical histological microscope slide marked with the same indicia shown in FIG. 1A.

FIG. 2 is an isometric view of an illustrated embodiment of the histological sample carrier image capture device according to the invention;

FIG. 3 is a side elevation view of the histological sample carrier image capture device shown in FIG. 2, with a side panel of the housing removed to expose some internal components.

FIG. 4 is an isometric view of an illumination module used in the image capture device.

FIG. 5 is a schematic diagram of one illustrated embodiment of an illumination electrical circuit.

FIG. 6 is a system diagram comprised of the software system modules for extracting histological sample carrier identification information, and for linking storage location descriptions.

FIG. 7 is a system diagram representing the software modules for changing the recorded status of tissue blocks.

### DETAILED DESCRIPTION OF THE PREFERRED EMBODIMENT

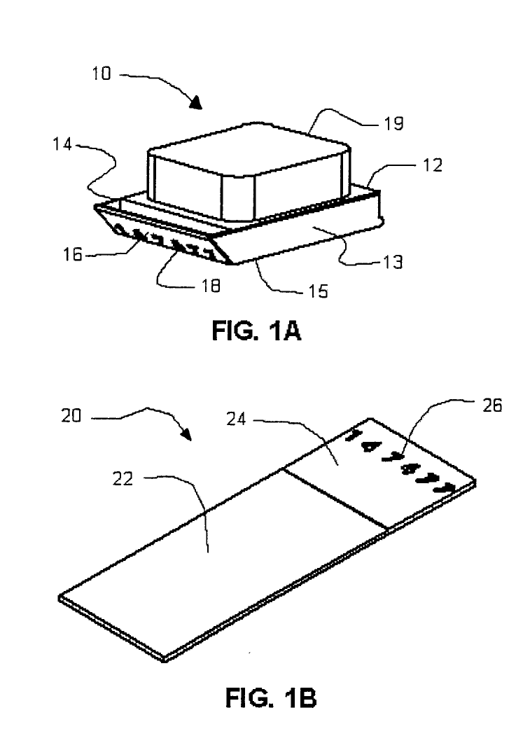

Referring now to FIG. 1A, one type of a histological sample carrier 10 used in connection with the present invention, and specifically of the cassette type described in U.S. Pat. No. 3,674,396, is shown generally at 10. Histological sample carrier 10 comprises a plastic tissue cassette 12 having opposed side surfaces 13 and 14, and a bottom surface 15. Tissue cassette 12 includes an indicia face 16, which is provided for marking with information such as alphanumeric identifying indicia. Indicia face 16 is angled relative to bottom surface 15, as illustrated. In FIG. 1A, indicia face 16 is shown marked with hand-written alphanumeric, eye-readable indicia 18 for block identification purposes. Readable indicia 18 may likewise be machine-written. A tissue sample is embedded in paraffin-wax 19, which is secured to cassette 12 and which is illustrated as a rectangular block of wax. The tissue sample embedded within the block of wax 19 is not shown in the present illustrations.

As noted above, tissue samples are acquired for examination from a histological sample carrier such as the tissue cassette 12 shown in FIG. 1A by slicing a thin section of the paraffin wax 19 that includes the tissue, then placing that sample on a slide. A typical glass microscope slide 20 for this purpose is illustrated in FIG. 1B, and comprises a transparent glass surface 22 and a slide indicia face 24. Slide indicia face 24 serves the same purposes as indicia face 16 of tissue cassette 12—that is, for marking the slide with sample identifying information. In FIG. 1B slide 20 is marked with hand-written alphanumeric indicia 26 that are the same as indicia 18 written on tissue cassette 12.

As used herein, the term “histological sample carrier” refers generally to a tissue-retaining member for holding histological tissue samples for storage, processing, examination and the like. The tissue cassette 12 illustrated in FIG. 1A and the slide 20 shown in FIG. 1B are two examples of histological sample carriers, but the term as used herein is not intended to be limited by these two examples.

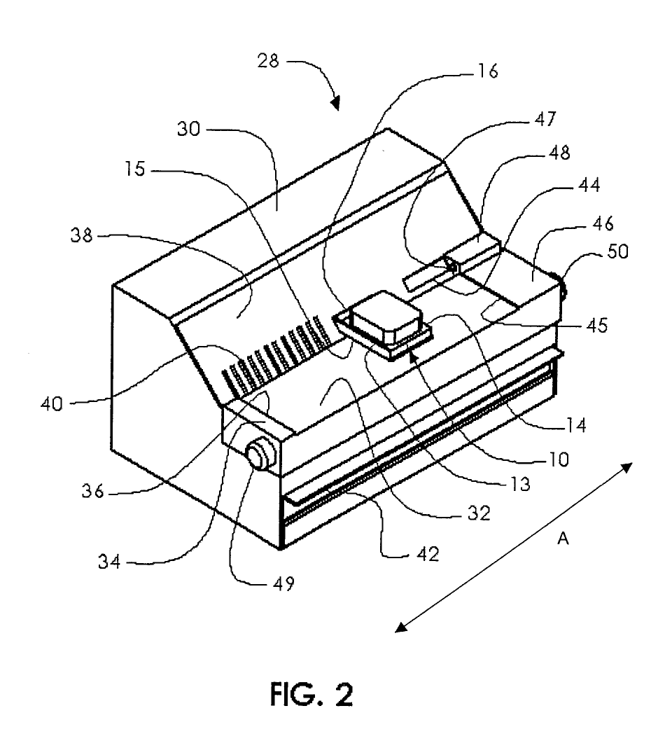

Turning now to FIG. 2, generally designated at 28 is an example of an image capture device that may be used to capture identifying information written on a histological sample carrier. Image capture device 28 includes a housing 30, which provides an opaque enclosure for the device components and a consistent indexing surface 32 for cassette bottom surface 15 when cassette 12 is placed on indexing surface 32 in the orientation shown in FIG. 2. Housing 30 may be fabricated from plastic or sheet metal and the like. A histological sample carrier 10 such as cassette 12 may be indexed on indexing surface 32 by placing side surface 13 coincident with a vertical surface that extends upwardly from indexing surface 32 to define a lip 36. Lip 36 is formed as part of a step 34 that may in turn be fabricated as a part of housing 30. The cassette 12 is oriented as shown in FIG. 2 on indexing surface 32 such that angled surface of indicia face 16 is abuts and is coincident with a heated borosilicate glass plate 38, or equivalent type of glass plate, which is oriented relative to indexing surface 32 such that the glass plate 38 is angled relative to the indexing surface at the same angle that indicia face 16 is angled relative to bottom surface 15 of cassette 12. As described below, glass plate 38 is heated to such a temperature as to quickly liquefy paraffin wax found on cassette indicia face 16.

A series of ridges 40 project outwardly from the surface of the glass plate 38 and are formed on glass plate adjacent the indexing surface 32 near step 34. Ridges 40 extend in a direction generally perpendicular to the plane of the indexing surface 32, and function as scraping members for removal of liquefied excess paraffin wax that is scraped from indicia face 16, as described below, and channel the liquefied wax down the outward facing surface of the glass plate 38 (“outward” referring to the direction outside of housing 30) and into a removable collecting tray 42. Ridges 40 are preferably a hardened coating material deposited on glass plate 38 in vertical lines that are about 0.5 mm thick. Except for a rectangular region identified in FIG. 2 as transparent window 44, the entire inward-facing surface of glass plate 38 (“inward” referring to the interior of housing 30) is coated with an opaque coating material that limits the transmission of light through the glass plate. Transparent window 44, which is located toward the lateral side of glass plate 38 opposite ridges 40, as shown in FIG. 2, permits cassette indicia face 16 to be viewed by camera 52 as described below and thus defines an image acquisition window.

A second step 46 located on indexing surface 32 defines a vertical indexing surface at a lip 45. When a cassette 12 is placed on indexing surface 32 such that side surface 14 abuts and is coincident with lip 45 of step 46, and such that cassette indicia face 16 abuts and is coincident with glass plate 38, cassette bottom surface 15 rests upon indexing surface 32. In this position, cassette indicia face 16 is aligned precisely with transparent window 44 so that the indicia face is within the field of view of a camera contained in housing 30, as described below. The perimeter dimensions of transparent window 44 are sized somewhat smaller than the perimeter size of cassette indicia face 16 so as to reduce the amount of ambient light that enters housing 30 from the exterior thereof, which could affect the camera brightness settings. By limiting the amount of ambient light entering the interior of the housing, accurate, consistent and repeatable results are obtained. Typically, the width and height of transparent window 44 may be approximately 0.5 mm less than the respective width and height of cassette indicia face 16. In addition, all objects outside of the device housing 30 are obstructed from the camera's field of view except for cassette indicia face 16, as it is visible to the camera through transparent image acquisition window 44.

A micro-switch 47, typically a pushbutton type switch, is mounted within pushbutton switch enclosure 48 in such a way that it is activated by cassette 12 side edge 14 when the cassette is located on indexing surface 32 with cassette indicia face 16 oriented such that it aligns with transparent window 44 and is thus within the camera's field of view. Micro-switch 47 is connected across the contacts of an image capture button built into camera 52 as described below. It will be appreciated that micro-switch 47 is but one example of a switch useful to activate the camera, and that it may be replaced with equivalent devices such as a reflective photo sensor that provides all the functionality of pushbutton micro-switch 47 in a non-contact manner.

Enclosure indexing surface 32, including attached steps 34 and 46, may be removed by the user for cleaning by unscrewing thumbscrews 49 and 50. Other components of the apparatus are also removable for cleaning.

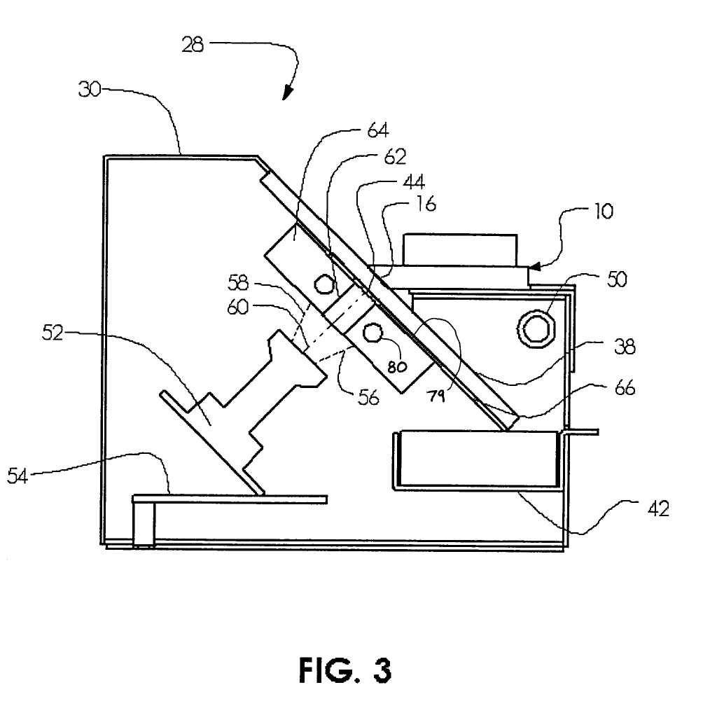

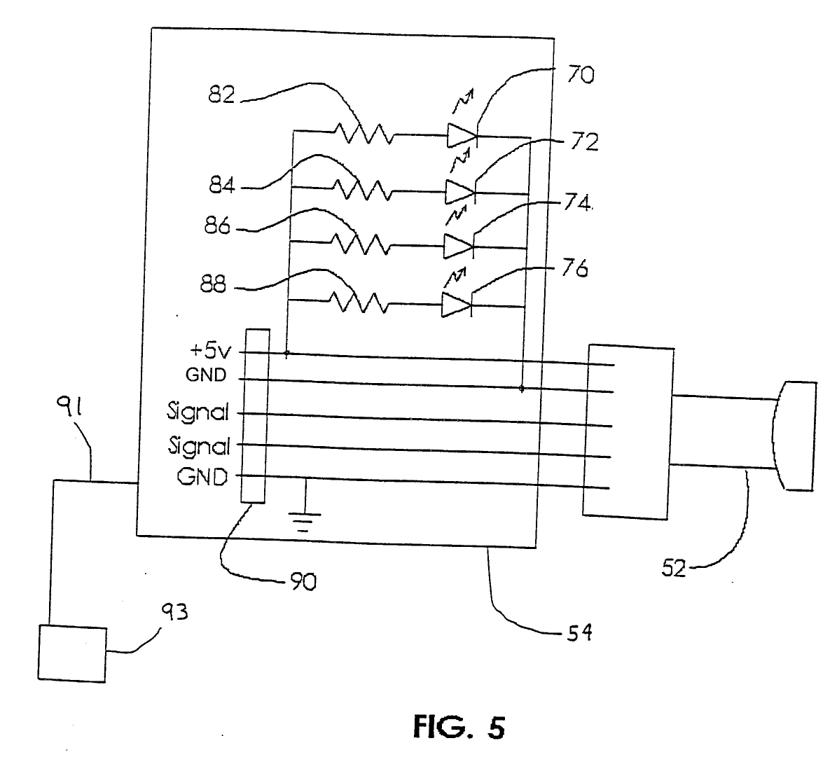

Referring now to FIG. 3, image capture device 28 defines an enclosure for a universal serial bus (USB) digital camera 52. A camera 52 suitable for use with image capture device 28 may be obtained from any one of numerous commercial sources. One suitable camera is the Logitech QuickCam™ Pro 3000, available from Logitech of Fremont, Calif. (www.logitech.com). In one illustrated embodiment, the USB cable of camera 52 is connected to printed circuit board (PCB) 54, shown in schematic form in FIG. 5. Camera 52 includes an image capture button that when activated sends a signal via the USB cable to cause a connected computer to capture an image from camera 52. In the illustrated embodiment, micro-switch 47 is connected across the contacts of the image capture button so that image captures may be triggered by activation of micro-switch 47. Camera 52 has a field of view shown by optical paths 56 and 58. The centerline 60 of the camera's field of view is normal to and centered on opening 62 in the illumination device light block 64 and transparent window 44 in glass plate 38.

As noted above, glass plate 38 is heated to liquefy any paraffin wax that may have accumulated on indicia face 16 of cassette 12. In the preferred embodiment a heating element 66 is secured by adhesive to the inward-facing surface of glass plate 38. Heating element 66 is preferably a resistive heating element, and more preferably about 2 mm thick, which is capable of maintaining the temperature of the outer-facing surface of glass plate 38 at a temperature above the melting point of all paraffin waxes that may be used to secure tissue samples to histological sample carriers. The preferred temperature for glass plate 38 is approximately 70 degrees Celsius, although it will be appreciated that this temperature may be adjusted widely and according to specific needs.

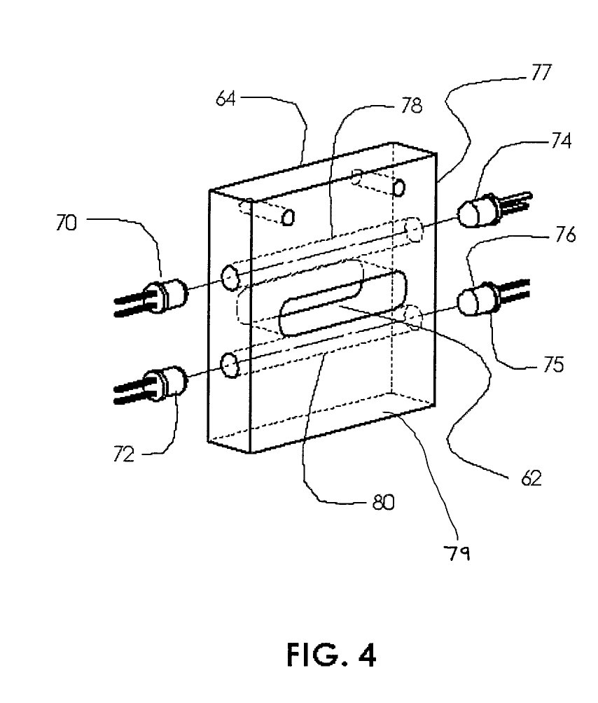

An illumination light block 64 according to the illustrated embodiment is shown in FIG. 4. Light block 64 is configured to cast shadowless, diffused and consistent illumination onto the indicia face of the histological sample carrier, such as indicia face 16 of cassette 12, to facilitate accurate and repeatable electronic capture of the indicia written thereon. The illumination block 64 comprises a light block 64 that is fabricated from a translucent material that assures good transmission of light through the light block. As examples, light block 64 may be fabricated of plastics such as 7328 sign white acrylic, or glass, both of which provide sufficient transmission and diffusion of light from light sources. Light is provided by four 5 mm white lights 70, 72, 74 and 76, which preferably are white light emitting diodes (LEDs) as shown in the drawing figures. Lights 70 through 76 are powered by an appropriate power source, and in the case of LEDs, by a 5 volt power source that may conveniently be provided through the computer-to-camera USB cable connected to PC board 54 as shown schematically in FIG. 5. Each of the four LEDs 70 through 76 are inserted into and secured within the opposite ends of two 5 mm diameter cross-drilled holes 78 and 80 drilled through light block 64, such that the annular rim at the base of each LED (such as rim 75 on LED 76) is coincident with light block face 77. White light emitted from the LEDs 70 through 76 or other light equivalent source is scattered radially from holes 78 and 80, evenly illuminating the outer surfaces of light block 64. Referring back to FIG. 3, it may be seen that light block 64 is mounted in housing 30 such that surface 79 of light block 64 is coincident with window 44. When the light block is mounted in this manner and LEDs 70 through 76 are illuminated, shadowless light is cast upon the indicia face of the histological sample carrier through transparent window 44 of glass plate 38.

Those of ordinary skill in the art will readily appreciate that any other equivalent illumination devices may be substituted for LEDs 70 through 76, and that the illumination devices may be powered by a separate power supply.

An opening 62 is formed through light block 64 in a position to allow the full area of indicia face 16 of cassette 12 to be viewed by camera 52. Stated in another way, opening 62 allows the entire indicia face 16 to be within the field of view of camera 52.

In FIG. 5 a representative circuit diagram of selected circuits of PCB 54 is represented schematically. USB cable 90 of camera 52 is connected via cable 91 to a controller such as a processor of an external computer 93 or another controller through PCB 54. It will be appreciated that computer 93 may just as well be incorporated into housing 30 to provide a self-contained unit. LEDs 70, 72, 74, and 76 are connected in parallel to the USB +5 volt power wire through current-limiting resistors 82, 84, 86 and 88, typically of 330-ohm resistance.

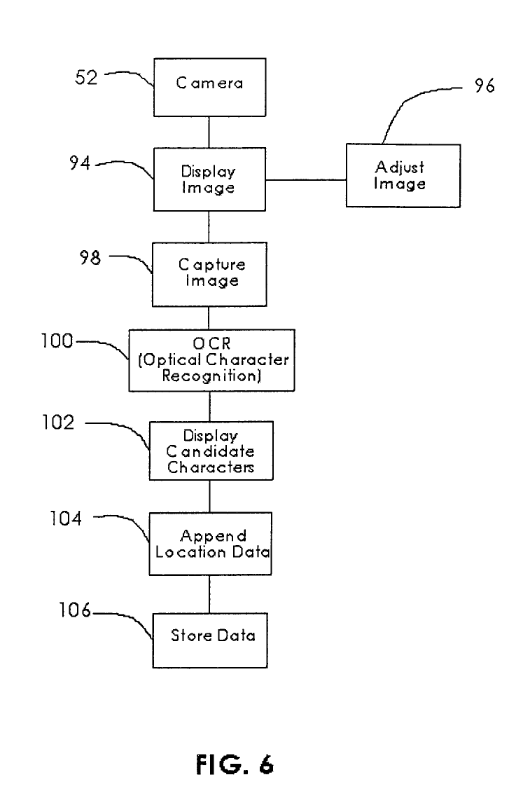

In FIG. 6, the software system is shown schematically in terms of representative modules. Camera 52 continually processes images in software module 94 and the images are displayed on display associated with computer 93. Digital image adjustment for brightness and other optical characteristics are controlled by module 96 and is preset by the user to achieve the greatest contrast between indicia 18 and cassette indicia face 16, based upon factors such as cassette color and ambient light intensity. When the user places a histological sample carrier such as cassette 12 correctly on indexing surface 32 such that indicia markings 18 are within the camera's field of view and micro-switch 47 is activated, image capture module 98 is activated and camera 52 generates a digital image of the indicia face 16. The image thus captured is redisplayed by the display associated with computer 93 and is automatically processed by optical character recognition (OCR) module 100. Software useful for OCR module 100 includes commercially available products such as EasyOCR, which is available from Euresys S.A., Anglur, Belgium (www.euresys.com). The processed output from OCR module 100 comprises a captured electronic representation of the information conveyed by the indicia 18.

In the preferred embodiment, the resulting electronic representation of the information conveyed by the indicia is displayed by module 102 for user confirmation of the accuracy of the information. After user confirmation of the electronic representation, the information displayed by module 102 is automatically linked with the preset description of the physical storage location of module 104 and saved in database 106, such as the database software product called Access™, which is available from Microsoft Corporation (www.microsoft.com). Moreover, the physical storage location is automatically incremented to the next physical storage location each time a sample is processed. In another embodiment, the electronic representation of the information conveyed by the indicia of module 102 is made available for use by another computer software program, eliminating the need for modules 104 and 106.

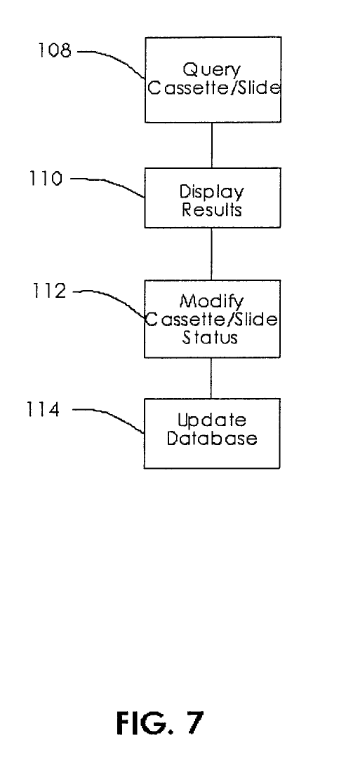

Referring now to FIG. 7, a software system for retrieving information about histological sample carrier storage location is described. Use of this system allows a user to rapidly identify the physical location of a specific histological sample carrier for retrieval. Module 108 processes queries for the retrieval of histological sample carrier location description data based on the block identification indicia entered by the user. Possible results of this query are displayed by module 110. The user selects the desired result from a list of possible candidates, and the user is given the option of modifying the status of the selected histological sample carrier through electronically marking the block status. As examples, the status could be modified to “removed” in module 112 if the selected histological sample carrier were to be removed from the physical storage location. The database is then updated by module 114. In addition, an audit trail or report of block identification indicia, locations, date, and status may be generated in response to user prompts.

Representative Use of the Invention

In use, the user activates and initializes the software system and selects a block storage location. With the image capture device powered so that heating element 66 is on, the user then places a histological sample carrier such as a cassette 12 onto image capture device 28 such that bottom surface 15 is in contact with indexing surface 32, cassette side surface 13 is in contact with lip 36 of sheet metal step 34, and cassette indicia face 16 is in contact with glass plate 38. The user then slides block 10 in the horizontal direction along indexing surface 32 in the direction indicated by arrow A in FIG. 2, all the while maintaining contact between cassette surfaces 15 and 16, and indexing surface 32 and glass plate 38, respectfully. Paraffin wax that may have found its way onto indicia face 16 is liquefied by the heated glass plate and is removed by the scraping action provided by ridges 40. The liquefied wax removed from indicia face 16 in this manner is channelled into collection tray 42 for removal.

The user continues moving cassette 12 in the direction indicated by arrow A until side surface 14 of cassette 12 is moved into contact with pushbutton micro-switch 47, thereby depressing and activating the switch. At the same time, side surface 14 abuts lip 45 and the cassette is at this time correctly positioned for data acquisition by computer 93. With switch 47 activated an electronic image of cassette indicia markings 18 is captured by software system module 98 using camera 52. The captured image is automatically processed by OCR module 100. The resulting electronic representation of the information conveyed by the indicia is displayed by module 102 for user confirmation that the electronic representation is the same as the written indicia. If the user confirms a match between physical cassette indicia 18 as displayed by module 94 and the electronic representation of the information displayed by module 102, the information of module 102 is automatically linked with the preset description of the physical storage location of module 104 and stored in database 106. If the user does not confirm, the electronic representation of the information conveyed by the indicia of module 102 may be edited by the user to match the physical cassette indicia markings of module 94 using any number of computer input devices, such as a keyboard. The data is then saved in database 106 as described before.

When the user wants to remove a block or slide from the physical storage location, computer database 106 is queried by module 108 using any of the following criteria; sample identification indicia, date, comment, status, or known location, or other location information that may be used. Possible matches, including descriptions of the storage location, are displayed by module 110. The user updates database 106 to indicate that the block or slide is removed and then proceeds to remove the block or slide from the physical storage location.

The preceding detailed descriptions, specifically of FIGS. 2 and 3, describe the histological sample carrier image capture device 28 as it may be configured for use with a cassette 12 as shown in FIG. 1A. The image capture device 28 may be configured for use with a histological sample carrier such as microscope slide 20, either by modification of the indexing surfaces relative to the camera's field of view, or by providing secondary loci on the indexing surfaces for reading indicia on indicia face 24.

Those of ordinary skill in the art will recognize that many different yet equivalent configurations of the image capture apparatus as well as the data extraction method may be used without departing from the scope and spirit of the present invention. As one example, the device 28 may be set up for automated placement and indexing of histological sample carriers on the indexing surface. Thus, a cassette 12 may be loaded into a carriage assembly configured for automated reciprocating movement along the axis defined by arrow A, while maintaining the indicia surface 16 and bottom surface 18 of cassette 12 in the proper orientation relative to the indexing surface 32 and glass plate 28, as described above. The image capturing components of the invention as detailed above coordinate with the carriage movement to automatically capture and display the indicia.

Therefore, while the present invention has been described in terms of various preferred embodiments, it will be appreciated by one of ordinary skill that the spirit and scope of the invention is not limited to those embodiments, but extend to the various modifications and equivalents as defined in the appended claims.

1. A method for electronically representing identification indicia on a histological sample carrier, comprising:
(a) illuminating indicia on a histological sample carrier;
(b) forming a digital image of the indicia; and
(c) processing the digital image to create an electronic representation of the information conveyed by the indicia.

2. The method of claim 1 including the steps of linking the electronic representation to a physical storage location of the histological sample carrier and saving the linked information in an electronic database.

3. The method of claim 2 including the step of confirming that the electronic representation is the same as the indicia on the histological sample carrier.

4. The method of claim 1 wherein the indicia on the histological sample carrier is hand-written and the processing step includes the step of OCR of the indicia.

5. The method of claim 1 including the step of removing paraffin wax from the histological sample carrier prior to step (b).

6. Apparatus for electronically representing identifying indicia marked on a histological sample carrier, comprising:
a housing supporting an indexing surface for indexing the histological sample carrier such that indicia on the histological sample carrier is coincident with an image acquisition window;
a light source contained in the housing;
a camera contained in the housing and having a field of view encompassing the indicia on the histological sample carrier when the histological sample carrier is indexed on the indexing surface;
a controller configured receiving data from the camera and programmed for converting the data into an electronic representation of thereof.

7. The apparatus of claim 6 including a heating element configured for heating an indexing surface.

8. Apparatus for electronically representing indicia marked on a histological sample carrier, comprising:
illumination means for illuminating the indicia;
digital camera means for generating a digital image of the illuminated indicia;
computer processing means for processing the digital image to extract the information conveyed by the indicia from the image, and for providing the information in electronic form.

9. The apparatus according to claim 8 including indexing means for positioning the histological sample carrier in a desired orientation relative to the digital camera means.

10. The apparatus according to claim 8 including heating means for heating a surface of the histological sample carrier on which indicia is marked to remove wax therefrom.

11. The apparatus according to claim 9 wherein the illumination means further comprises a translucent light block positioned between the histological sample carrier and the digital camera means, and including at least one light source for illuminating the light block.

12. The apparatus according to claim 11 wherein the light block further includes an opening positioned relative to the digital camera means so that indicia on the histological sample carrier are in a field of view of the digital camera means through the opening.

13. The apparatus according to claim 12 wherein the illumination means includes alignment surface means for positioning the histological sample carrier in a predetermined position with respect to the opening.

14. The apparatus according to claim 8 wherein the computer processing means further comprises information storage means including:
means for recording a description of a physical storage location;
means for linking the recorded description of the physical storage location to the electronic representation of the information conveyed by the indicia; and
means for retrieving the description of the physical storage location for a selected histological sample carrier.

15. The apparatus according to claim 8 wherein the image processing means comprises OCR for extracting the information conveyed by the indicia.

16. An apparatus for acquiring images of identification indicia printed on histological sample carriers comprising:
a light configured to cast shadowless illumination on the indicia printed on the histological sample carrier;
a camera having a field of view encompassing the indicia printed on the histological sample carrier;
an indexing surface configured to locate the histological sample carrier in a predefined position with respect to the light and camera such that the indicia is within an image acquisition window; and
a switch connected to the camera and operable when a histological sample carrier has been placed in the predetermined position to cause the camera to capture a digital image of the indicia through the image acquisition window.

17. The apparatus according to claim 16 further including a programmable controller programmed to create an electronic representation of the information conveyed by the indicia.

18. The apparatus according to claim 16 further including a heater for heating a surface of the histological sample carrier on which indicia is printed to remove wax therefrom.

19. The apparatus according to claim 16 wherein the histological sample carrier is a histological tissue cassette.

20. The apparatus according to claim 16 wherein the histological sample carrier is a slide.
